(19) United States
(12) Patent Application Publication
(10) Pub. No.: US 2001/0051037 A1
(43) Pub. Date: Dec. 13, 2001

(54) Personal versatile recorder: enhanced features, and methods for its use

(75) Inventors: Reem Safadi, Horsham, PA (US); Tom Du Breuil, Ivyland, PA (US); Mark DePietro, Harleysville, PA (US); Charles Rosso, Churchville, PA (US)

Correspondence Address: RADER FISHMAN & GRAUER PLLC, LION BUILDING, 1233 20TH STREET N.W., SUITE 501, WASHINGTON, DC, 20036, US

(73) Assignee: General Instrument Corporation

(21) Appl. No.: 09/810,667

(22) Filed: Mar. 19, 2001

Related U.S. Application Data
(63) Continuation-in-part of application No. 09/520,968, filed on Mar. 8, 2000.

(51) Int. Cl. H04N 5/92; H04N 5/445; G06F 3/00; G06F 13/00

(52) U.S. Cl. 386/83; 386/94; 725/39

(57) ABSTRACT

Described are methods and apparatus to enhance the use and recording features of the personal versatile recorder. A method and apparatus for accurately recording selected events despite the ambiguity of start and end times is described. The recording is done by a personal versatile recorder that is connected to, or integrated in, a cable television set-top terminal, satellite, off-air or other wireless receiver. Also described is a method and apparatus for handling pay-per-view events, as well as wirelessly accessing and recording of various content on other connected peripherals. The personal versatile recorder includes a central processing unit and a hard drive for mass data storage. Preferably, the personal versatile recorder and associated set-top device have dual tuners for receiving and recording one or more transport streams from the cable system as well as analog or digital audiovisual programming.

### RELATED APPLICATIONS

This application is a Continuation-in-Part of U.S. patent application Ser. No. 09/520,968 entitled, “ Personal Versatile Recorder And Method Of Implementing And Using Same,” filed on Mar. 8, 2000.

### FIELD OF THE INVENTION

The present invention relates to the field of multimedia recording and playback. More specifically, the present invention relates to a personal versatile recorder for connection to a communication network. The personal versatile recorder of the present invention is used for recording, transcoding, retrieval, and playback of audiovisual programming and caching of either streaming data or a wide variety of multimedia data files and formats, including, but not limited to, compressed audiovisual files, HyperText Markup Language (HTML) files, audio files, video or picture files, electronic mail (e-mail), or any combination of the above, facilitating a wide variety of real time and non-real time applications.

### BACKGROUND OF THE INVENTION

Television is widely used in modern society as a source of both information and entertainment. Multiple-channel programming networks, such as high bandwidth cable, multi-channel broadcast television, direct broadcast satellite, multi-channel multipoint distribution service, satellite master antenna television, and the like, supplement over-the-air broadcast systems to provide dozens or even hundreds of additional channels of programming to a viewer. Additionally, the current trend is for multiple-channel programming networks to provide additional services such as Internet access.

The multiple systems operator (MSO) distributes premium television programming over a multiple-channel programming network for a subscription fee. While such programming provided to the viewer includes premium channels, it also includes pay-per-view programming. Pay-per-view programming is a technique used by the MSO to offer premium programming to its system subscribers. Using this technique, the particular event is selected and individually purchased by the subscriber for an additional fee. Depending upon the operation and administration of the multiple-channel programming network, a pay-per-view program (also known as a pay-per-view event) can be purchased using payment systems that include, but are not limited to, customer service representatives, automated response units, impulse-pay-per-view, or video-on-demand.

When a customer service representative is used to order pay-per-view programming, the subscriber places a telephone call to a service center and the representative answering the call will place the order into the system. But when an automated response unit is used, although the subscriber places a telephone call to a service center, the call is automatically answered and processed, typically by a computer. Impulse pay-per-view allows the subscriber to purchase the event without placing a call to a service center. Instead, the event can be purchased in the home from an event menu shown on the television screen. When video-on-demand is alternatively used to order an event, that event is presented to the subscriber for immediate viewing, regardless of the placement time of that order.

The shear volume of available programming causes difficulties for the viewer. For example, two programs the viewer wishes to watch could be broadcast simultaneously. Also, a program the viewer wishes to see could be broadcast at an inconvenient time. These problems are overcome by recording devices such as a video cassette recorder (VCR).

A VCR allows the user to record incoming audiovisual programming while watching a different channel. The VCR also allows the user to record programming when the user is away and cannot watch the desired programming. Consequently, the VCR allows the user to capture programming that would otherwise be missed, so that that programming is viewed at the user's convenience.

The basic concept of the VCR has recently been extended to digital compression devices that provide even more features for managing the reception and recording of audiovisual programming. These products have a number of names such as personal television products, personal versatile recorders, video recording computers, personal television servers, and the like, referred to hereinafter as “personal versatile recorders” (PVR). Current examples of personal versatile recorders include the TiVo® system made by TiVo, Inc. and the ReplayTV® system made by ReplayTV, Inc.

A personal versatile recorder provides, to the viewer, recording and retrieval functions for the playback or examination of multimedia content. This device supplants the video cassette recording medium with a hard drive internal to the recorder. Connected between a user's television set and cable box, satellite receiver or antenna, the personal versatile recorder controls the channel tuned on the television, provides an interactive electronic program guide and records programming on a manual or timer-controlled basis. Additionally, the personal versatile recorder buffers incoming audiovisual programming so that the viewer can pause a live television program or replay a portion of a live television program without missing any subsequent segment of the program, as long as the duration of programming to be captured during the pause or replay does not exceed the capacity of the recording medium. Similarly, the viewer can choose to record an entire program after watching it for some time, so long as the recording is started and completed before the capacity of the recording medium is exceeded.

In even more advanced features, the personal versatile recorder can be programmed to regularly record a user's favorite programs, and then also record other programs of the same genre that the user may be interested in watching. Thus, the personal versatile recorder may assist a user in viewing audiovisual programming that the user is interested in, but unaware of, at the time of its broadcast.

While the personal versatile recording system offers many advantages over the conventional video cassette recorder, there are still shortcomings in the personal versatile recorders presently available. For example, programming events having variations in the starting time or ending time from the originally posted time (such as live sporting events) pose a challenge when the consumer wishes to record such events. Specifically, when the broadcast time period for a program unexpectedly extends beyond the expected time period, the consumer typically records the program for the expected time period only to discover that the program segment that has aired during the additional time period was not recorded. Thus, when the program overruns or exceeds its allotted time slot, extra recording time must be added to ensure that the entire program is recorded. With some personal versatile recording devices, the consumer can manually and arbitrarily enter the start and stop times in attempting to compensate for these programming schedule variations. However this is not optimal since this approach does not guarantee the recording of the program segment that has aired during the additional time period, or it may unnecessarily extend the recording period, thereby using an excessive amount of storage space on the recording medium.

As another example of the difficulties for the viewer caused by the shear volume of available programming, the consumer must often record over previously recorded programming/content to subsequently record an event due to the limited storage space on the recording medium of the presently available personal versatile recorders. Once this situation arises, the previously recorded programming/content is expunged from the recording medium. When this previously recorded programming/content is a pay-per-view event, the subscriber is nonetheless charged the purchase fee for the recorded, yet unviewed, programming/content.

Consequently, there is a need in the art for a method and apparatus that ensures that the selected programming is recorded in its entirety despite schedule changes and program overruns that may occur.

Moreover, there is an additional need in the art for a method and apparatus that ensures that the subscriber is not charged a purchase fee for a pay-per-view event that was purchased, but not viewed.

### SUMMARY OF THE INVENTION

It is an object of the present invention to meet the above-described needs and others. Specifically, it is an overall object of the present invention to provide a personal versatile recorder that provides the advantages of a personal versatile recorder while managing multimedia data in a wide variety of other possible file and streaming formats. Furthermore, it is an object of the present invention to provide a method and apparatus that alleviates caching and transmission difficulties currently experienced in webcasting streaming audiovisual signals.

Additional objects, advantages and novel features of the invention will be set forth in the description which follows or may be learned by those skilled in the art through reading these materials or practicing the invention. The objects and advantages of the invention may be achieved through the means recited in the attached claims.

To achieve these stated and other objects, the present invention may be embodied and described as a personal versatile recorder for recording any type of data. The personal versatile recorder of the present invention is preferably integrated with a set-top terminal to share a common central processing unit; associated firmware and software, decoding and security elements, interfaces, and the like, as well as a data storage device; a connection for receiving audiovisual programming; and for receiving one or more data transport streams. The same connection may serve both functions by receiving both audiovisual programming transport streams and at least one data transport stream, e.g. a cable television system interface.

In accordance with the present invention, an event is selected for recording using a personal versatile recorder. The personal versatile recorder is then programmed to record the selected event in its entirety despite the occurence of a schedule change or a program overrun. The personal versatile recorder of the present invention may register with an electronic programming guide server so that the personal versatile recorder is notified by the electronic programming guide server when the selected event has ended. Upon completion of the selected event, the electronic programming guide server would either send at least one multicast message to the personal versatile recording apparatus to notify the personal versatile recorder that the selected event has ended, or broadcast the end time for the selected event regardless of the time the personal versatile recorder has been instructed to use for recording the selected event.

As an alternative feature of the present invention, data produced and updated in near-real-time by an electronic programming guide server may be used by the personal versatile recorder to determine the appropriate start and end times for recording the selected event. Recording of the selected event begins at a first time period that is immediately before the starting time of the selected event. The recording procedure is then halted at a second time period that is immediately after completion time of the selected event. The produced and updated data may include first time period and second time period. Using this alternative feature, portions of the recorded program that have been recorded before the first time period and after the second time period may then be deleted from said recorded program by the personal versatile recorder.

As an additional alternative feature of the present invention, a tag may be placed within a program stream corresponding to the selected event. This tag, including a program start indication and a program end indication, may either be placed in a descriptor located within a program map table, or may be a separate message. If the selected event is a live event, then placement of the tag may require manual oversight at the source of the program stream.

As another feature of the present invention, encompassed is the feature wherein the personal versatile recorder includes an interface for recording from another peripheral device such as an FM tuner, a compact disk (CD) player, a digital versatile disk (DVD) player, or a Moving Pictures Expert Group (MPEG) Level 3 (also known as MP3) player. When the personal versatile recorder has a CD writing capability, a custom personal CD may include selected content, such as favorite music files which may be played in other CD players. The MSO may choose to enable this feature on an individual PVR basis for an additional charge.

Another novel feature of the present invention relates to the personal versatile recorder being incorporated into a wireless home network. Moreover, the selected event for recording may prefereably be music that conforms to a listener profile. The music may be recorded onto a compact disk. The personal versatile recorder tags, for recording, the music that is in progress to record that music at a later time.

As a feature of the present invention, a pay-per-view event is registered upon reading pay-per-view event from a storage medium incorporated with the personal versatile recorder. The pay-per-view event signal is modulated and transmitted by the MSO for receipt by the personal versatile recorder. Upon receipt, the personal versatile recorder demodulates the pay-per-view event signal to produce a data bit stream. This bit stream is decrypted, decoded and converted into an analog signal. When recording of this signal is desired, the analog signal is converted into a digital stream, which is encoded, transcoded, optionally re-encrypted, and stored on the storage medium. The re-encryption scheme need not be identical to the original encryption scheme of the demodulated signal. Additionally, when transcoding is desired, an analog-to-digital conversion is performed to the analog audiovisual signal for re-encoding into a re-compressed data bit stream. The re-compressed bit stream is then transcoded to the desired compression rate, signal format and/or resolution, then stored onto storage medium. Furthermore, transcoding may be performed without the intermediate step of converting the compressed bit stream into an analog audiovisual signal. Moreover, when transcoding is not required, the encrypted, compressed bit stream is stored prior to decompression and is decrypted prior to conversion into an analog audiovisual signal.

When the pay-per-view event read from the storage medium, it is registered as having been accessed for viewing. At the option of the subscriber, a purchase fee for the pay-per-view event is applied when the pay-per-view event is viewed. Alternatively, the subscriber may elect the option of being charged a partial charge when pay-per-view event written to the storage medium, and an additional partial charge when pay-per-view event event is viewed, wherein the sum total of the partial charge and the additional partial charge amounts to the purchase fee.

As another alternate feature of the present invention, a preview time period authorization is contained within a secured message that is sent from the headend to the personal versatile recorder. This preview time period authorization permits the viewing of the pay-per-view event without charge during the preview time period. Once the preview time period has lapsed, the purchase event is registered as viewed by reporting the event back to the billing controller and the purchase fee is applied.

As another novel feature of the present invention, the personal versatile recorder performs an inquiry to determine the existence of the permission needed to maintain the content on the storage medium.

These and other features are explained below.

### BRIEF DESCRIPTION OF THE DRAWINGS

The accompanying functional drawings illustrate the present invention and are a part of the specification. Together with the following description, the drawings demonstrate and explain the principles of the present invention.

FIG. 1 is a block diagram of a personal versatile recorder according to the present invention.

### DETAILED DESCRIPTION OF THE PREFERRED EMBODIMENTS

Using the drawings, the preferred embodiments of the present invention will now be explained. These functional embodiments are illustrative and chosen for exposition of the principles of the present invention. The invention is not, however, limited to the following embodiments, as will be appreciated by those skilled in the art.

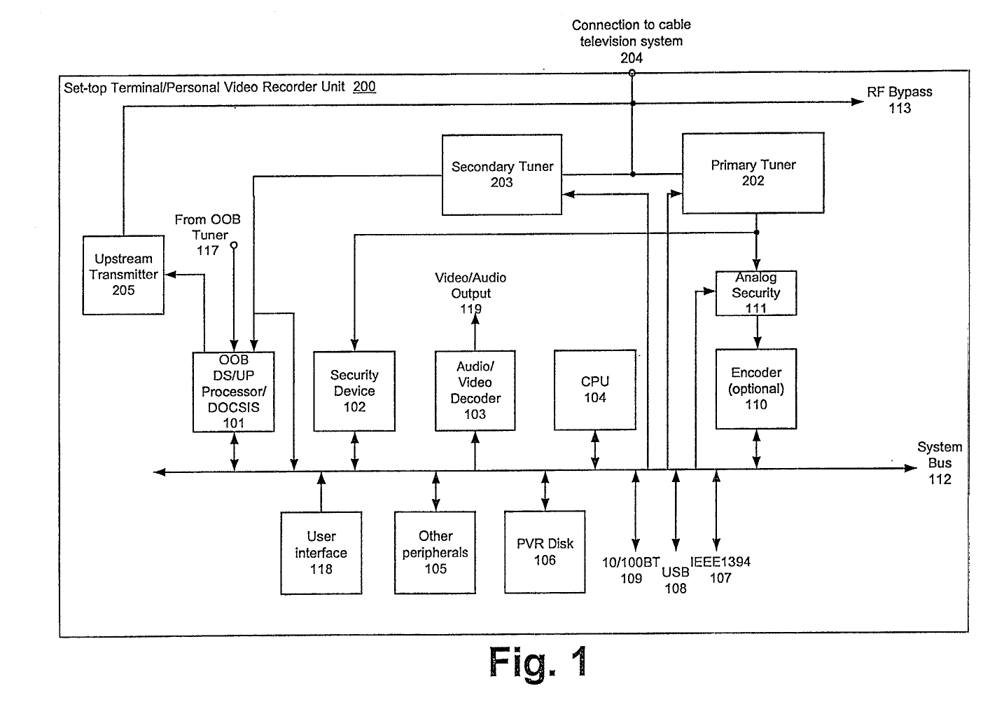

Depicted within FIG. 1 is the set-top terminal/personal versatile recorder unit (200) of the present invention. Incorporating a personal versatile recording device integrated along with a set-top terminal, the set-top terminal/personal versatile recorder unit (200) performs all functions of a traditional set-top terminal while performing additional features that include, but are not limited to, recording, buffering, and retrieving multimedia content.

This multimedia content includes, but is not limited to, audiovisual programming such as compressed or pre-compressed programming. Audiovisual programming is not limited to a single video stream, e.g., a single camera angle, but can also include user-selectable multiple camera angles. Similarly for the audio, it may contain multiple audio streams, that are user selectable The audiovisual programming, such as a television broadcast, webcast programming or any streamed or non-streamed content, can be received by the set-top terminal/personal versatile recorder unit (200) either as an analog signal or as an MPEG-2 digital data stream, Internet Protocol, and the like. This multimedia content also includes video files, picture and graphics files, audio files, HTML files, text files, application software files, e-mail, universal resource locator (URL) links, and the like.

The set-top terminal/personal versatile recorder unit (200) also provides access to the Internet, and performs as a personal versatile recorder to record and playback any multimedia content.

Incorporated within the set-top terminal/personal versatile recorder unit (200) is the user interface (118). The user interface (118) permits the user to control and interact with the set-top terminal/personal versatile recorder unit (200). The user interface (118) comprises any control devices with which the user inputs commands to the set-top terminal/personal versatile recorder unit (200) such as a keypad, a keyboard, a microphone, a trackball, a joystick, knobs, dials, switches, and the like. The user interface (118) inputs commands to application software executed by the central processing unit (104). This software provides display menus which are navigated using a remote control unit (not shown). This remote control unit, which is an integral part of the user interface (118), wirelessly transmits commands to the set-top terminal/personal versatile recorder unit (200). The user interface (118) also permits the entry of commands to the corresponding applications that are executing on the central processing unit (104) to perform the features that include, but are not limited to, the recording of multimedia content, the selection of content to be downloaded from the Internet, and the selection of other operations or setting other parameters associated with an agent application.

Multimedia content that is transmitted as digital data from the MSO to the set-top terminal/personal versatile recorder unit (200) is transmitted using Quadrature Amplitude Modulation (QAM). Using QAM, digital data bit streams are modulated onto an RF carrier signal in mode such that the value of each data bit is ascertained based on the phase and amplitude of the RF carrier signal. The QAM RF carrier signal is then demodulated to recover the transmitted data using the primary tuner (202) or the secondary tuner (203), which are both in-band tuners, or the OOB data tuner (117), which is an out of band tuner.

Digital data, multimedia files and application software, are also transmitted to the set-top terminal/personal versatile recorder unit (200) over the cable television system on an out-of-band (OOB) control channel to the OOB data tuner (117). Although for bandwidth capacity considerations, the in-band (primary tuner) or the secondary in-band tuner are more suitable. An OOB data channel is utilized primarily to facilitate conditional access functions for traditional and emerging services offered by the cable system operator as described in the prior art.

As shown in FIG. 1, the set-top terminal/personal versatile recorder (200) of the present invention also includes a primary tuner (202). The primary tuner (202) is preferably a broadband tuner that is used to tune a particular program offered over one of the hundreds of channels available from the cable system. The multimedia content received through the primary tuner (202) is buffered and selectively recorded on the personal versatile recorder disk (106) under the control of the central processing unit (104). Additionally, other data may be embedded within the television signal received through the primary tuner (202).

The secondary tuner (203) is used mainly to tune to the data transport stream within the signal from the cable television system (204) to free the primary tuner (202) for more conventional tuning of a television channel that the user desires to receive. This secondary tuner (203) may operate in accordance with any multiple access modems which facilitate bi-directional communication between the set-top terminal/personal versatile recorder unit (200) and the headend (not shown).

The second purpose of the secondary tuner (203) is to optionally allow for the respective recording and watching of separate audiovisual programming offered at two distinct frequencies, i.e., on different channels, or from different sources, i.e. streamed audiovisual content from the Internet and broadcast television programming. The Data Over Cable Service Interface Specification (DOCSIS) standard is used to facilitate Internet access in cable systems. The data transport stream from the DOCSIS tuner (203) is provided to a DOCSIS modem (101). The connection to the DOCSIS tuner (203) allows the central processing unit (104) to control which data stream is provided to the DOCSIS modem (101) in cases where there are multiple data transport streams comprised within the signal from the MSO.

The DOCSIS modem (101) communicates with the central processing unit (104) over the system bus (112), and incorporates an upstream processor that drives the transmitter (205) to facilitate upstream DOCSIS transmission as well as to support existing report-back protocols (101) used to manage the cable television system. Additionally, for bi-directional communication, an upstream transmitter (205) is provided in connection with the DOCSIS modem (101). The DOCSIS modem (101) thus provides bi-directional communication for Internet access, user requests of web pages, files, session requests, purchase requests, and the like.

The secondary tuner (203) is also used in conjunction with the primary tuner (202) to simultaneously watch two different television channels or audiovisual data streams. Control lines to the primary tuner (202) and the secondary DOCSIS tuner (203) are provided from the system bus (112). This allows the user to input tuning commands to the system using the user interface (118) so as to control the channel tuned by the primary tuner (202). Consequently, the two-tuner configuration allows for, inter alia, the following operating modes of interest:

a) watching an analog channel, recording a digital program (encrypted or in the clear);

b) watching a clear digital program and recording a digital program (encrypted or in the clear);

c) watching an encrypted program and recording an analog channel or a second digital program in the clear; and

d) watching picture-in-picture, where the first signal is received from the primary tuner while the second is played back or retrieved from the personal versatile recorder disk (106).

For cases a through d, as set forth hereinabove, involving an encrypted (enciphered) MPEG-2 stream, the stream goes through the security device (102) for decryption (deciphering). Such decryption is achieved within the set-top terminal/personal versatile recorder unit (200) using the Data Encryption Standard (DES) algorithm. DES is 64-bit Federal Information Processing Standard (FIPS) cryptographic algorithm that includes a bit key having a length of 56-bits. Using this algorithm, encrypted data passing through the security device (102) are decrypted to be converted into its unencrypted form. When the decrypted signal is to be watched (instead of being recorded), it is processed by the decoder (103).

When the television signal for that channel is an analog signal, it is then transmitted to the system bus (112) through an analog security circuit (111) for descrambling the signal when the signal is scrambled, and through an optional encoder (110) for hardware assisted compression. If the set-top terminal/personal versatile recorder unit (200) is intended to process and record only digital programming, as analog transmission is phased out, the analog security (111) and the encoder (110) as illustrated are no longer necessary. Nevertheless, the encoder (110) may be retained for encoding other analog signals from alternate analog input sources for other applications.

The personal versatile recorder (PVR) disk (106), connected to the system bus (112), provides a mass data storage medium on which the central processing unit (104) caches or records any type of multimedia content. The personal versatile recorder disk (106) includes a hard drive, magnetic disk, optical disk, magneto-optical disk or the like. If the audiovisual data is streamed, e.g. webcast, data could be written onto the personal versatile recorder disk (106) for caching purposes (subsequent use by the application software on a dynamic basis) or could be permanently stored.

The set-top terminal/personal versatile recorder unit (200) of the present invention is also used to perform a caching function that decreases the bandwidth demands placed on the connected network and enhances data retrieval rates. For example, some web sites, content, and the like, could include audiovisual elements that are always constant. Therefore, rather than downloading these elements each time that web site or the content is accessed, those constant elements are recorded, or cached on the personal versatile recorder disk (106) of the recorder and retrieved from there. This decreases the bandwidth demand on the network and decreases the time required to provide the display desired by the user.

Within the audio/video decoder (103), the content is decoded, converted to an analog signal, then provided to the video/audio output (119). For example, when the decrypted content is to be viewed instead of being recorded, it is processed by the audio/video decoder (103). Additionally, the audiovisual signal recorded on the personal versatile recorder disk (106) is retrieved and processed through the audio/video decoder (103) and then provided to the video/audio outputs (119) of the set-top terminal/personal versatile recorder unit (200).

Another function performed by the personal versatile recorder of the present invention is called transcoding. The data must be decompressed for optimal display and compressed for storage on the disk (106). This compression and decompression of multimedia data is performed by the central processing unit (104) and is known as transcoding. Transcoding is either performed in real-time so that MPEG-2 or streamed audiovisual programming is displayed or stored for offline transcoding. If transcoding is performed offline, the compression rate of the compressed stream is varied as desired by the user to tradeoff amount of storage space required by the compressed signal versus signal quality. The user controls the transcoding performed by the recorder through the user interface (118).

Interfaced with a system bus (112), the central processing unit (104), with associated firmware and software, executes software necessary to extract, display and record multimedia content to the personal versatile recorder disk (106). The central processing unit (104) activates or executes browser software at the user's request to display the HTML file on the screen of television set when an HTML file is stored on the personal versatile recorder disk (106). When the file contains additional URLs that the user wishes to examine, then the application uses the DOCSIS path to contact the corresponding server.

When an image file is stored on the personal versatile recorder disk (106) or received through the DOCSIS modem (101), the central processing unit (104) executes image manipulation software with which the image file is displayed on the television set.

The application software necessary to retrieve or “play” the multimedia files on the personal versatile recorder disk (106) is also stored on the personal versatile recorder disk (106) for use by the central processing unit (104). When a video or an audio file is stored on the personal versatile recorder disk (106) or received through the DOCSIS modem (101), the central processing unit (104) executes the player program software application to provide video and/or audio signals to the television set connected to the video/audio outputs (119).

The smart agent is a software application, also executed by the central processing unit (104), that automatically tunes, records, acquires or caches the multimedia content for later review by the user as specified by parameters input by the user. This software application has pre-established content rights management capabilities incorporated therein. Content rights management capabilities, include but are not limited to, those provided under the framework of the Secure Digital Music Initiative (SDMI) (incorporated herein by reference), and the like. The SDMI standards include a framework to guide content management implementation in personal electronic devices, music-playing software and digital music recordings to prevent or limit a user's ability to make unlawful copies of those copyrighted multimedia content. When the necessary or desired application software, along with associated content rights management, is not provided on the personal versatile recorder disk (106), the necessary or desired application application software is also downloaded through either of the primary and secondary tuners (202, 203), and then stored on the personal versatile recorder disk (106) or in memory (not shown).

The set-top terminal/personal versatile recorder unit (200), when coupled with content management software, provides a basis for a recorded content storage library by incorporating corresponding capabilities such as categorization and search functions. The smart agent application software is also used to develop a set of user profiles. When the smart agent application software contains contents rights management capability, content conforming to these developed profiles is selectively recorded onto the Personal versatile recorder disk (106), or onto a similar recording medium, depending on what access rights the user has for this content. Custom compact disks are recorded when a recordable or rewritable compact disk, instead of the personal versatile recorder disk (106), is used as the storage medium. This concept equally applies to storage devices and media other than the compact disk. For example, a compact flash device, or other recordable medium are used instead of a compact disk.

In addition to recording music conforming to developed profiles, the present invention also includes the ability to identify and “tag” a song that is in progress for recording at a later time. These recording features, which honor content rights management, facilitate consumer convenience and generate an additional source of revenue to the MSO and/or the music studios and artists.

The smart agent application also monitors an electronic programming guide for television programming of interest to the user based on user-input parameters and also ensures that the selected programming is recorded in its entirety despite schedule changes and overruns that may occur.

The smart agent application provides the recording flexibility to accommodate programming that extends beyond a given time period, thus, greatly enhancing the accuracy and the granularity of the recording period for programs with unpredictable start/end times. As a result, the duration of live events is determined with a small margin of error, and without using an excessive amount of storage space on the recording medium.

This flexibility is accomplished by receiving a broadcast message from a designated event scheduler that provides programming schedules, such as an electronic programming guide (EPG) server (not shown), to inform the set-top terminal/personal versatile recorder unit (200) when to halt the recording procedure. Pursuant to this approach, the consumer programs the set-top terminal/personal versatile recorder unit (200) to record the desired event, using the user interface (118). The set-top terminal/personal versatile recorder unit (200) registers with the electronic programming guide server so that the set-top terminal/personal versatile recorder unit (200) is notified by the electronic programming guide server when the event has actually ended. When the event has ended, the electronic programming guide server sends at least one multicast message to the set-top terminal/personal versatile recorder unit (200) to notify the registered set-top terminal/personal versatile recorder unit (200) that the event has actually ended. In lieu of sending at least one multicast message, the electronic programming guide server may broadcast the event end time regardless of the event time that has been previously programmed into the set-top terminal/personal versatile recorder unit (200). The broadcast approach eliminates the need for the set-top terminal/personal versatile recorder unit (200) to register because the message is sent to the set-top terminal/personal versatile recorder unit (200) on the network, hence, the network traffic is considerably reduced.

Alternatively, this recording flexibility is accomplished by continually updating, in near-real-time, the data produced by the electronic programming guide server. This data is then used by the set-top terminal/personal versatile recorder unit (200) to determine the appropriate start and end times for the desired programs. Pursuant to this approach, the consumer programs the set-top terminal/personal versatile recorder unit (200) to record the desired event, using the user interface (118). The smart agent application software continuously monitors data from the electronic programming guide server for any new or changed data; new or changed data from the electronic programming guide server is prioritized for network delivery. The smart agent application also controls the recording of this event onto the personal versatile recorder disk (106) for subsequent review by the consumer. As a result, recording of the desired event onto the personal versatile recorder disk (106) is initiated and halted by the agent application based on the most current information from the electronic programming guide server. In addition, according to this alternative embodiment, the agent application may control the recording of the event by beginning the recording procedure at a first time that is immediately before the starting time of that event and ending the recording procedure at a second time that is immediately after the completion time of that event, the first time and the second time being determined in near-real-time by the updated data produced by the electronic programming guide server. Moreover, according to this alternative embodiment, the agent application may control the duration of the event after the event has been recorded. In particular, a short time after recording the event, the agent application may use the updated, near-real-time data produced by the electronic programming guide server to accurately establish the times when the event has started and ended. By accurately establishing these times, the portion of the event that has been recorded before the event has started and after the event has ended is then deleted from the recording. This procedure is applicable to the recording of an event having a “modified” start time (e.g., for programs that are preceded by promotional segments as currently produced by Public Television stations). Furthermore, this procedure offers two benefits to the consumer in that it provides a clean recording (the consumer gets exactly the program they want with nothing more) and it frees up the disk space used by the excess recording time, making room for additional recording capacity on the personal versatile recorder disk (106).

Moreover, recording flexibility is accomplished by tagging the program stream corresponding to a given program with program start indication and a program end indication. This is done in a number of ways. First, tagging of live events may require manual oversight at the source the program stream. Alternatively, implementation the beginning and the end of the program is indicated in a descriptor placed in a program map table (PMT). As another option, a descriptor is placed as a separate message indicating the beginning and the end of the program.

Another feature of the set-top terminal/personal versatile recorder unit (200) of the present invention provides the MSO the choice of offering multimedia content in accordance with user preferences and/or user demographics. The content is delivered to one or a group of set-top terminal/personal versatile recorder units (200) in an encrypted format having particular demographics and/or preference criteria at certain timeframes or when requested by a given user. For example, the MSO advertises that a program or movie is offered for viewing for a certain duration, a day, a week, and the like. The viewer selects the download option, which is then performed as a background procedure when the content becomes available for viewing after a specified timeframe. This option is offered to the user as content that is purchasable “on demand”.

The set-top terminal/personal versatile recorder unit (200) provides for the storage of multimedia content in an unencrypted format. But when content that has been stored in an encrypted format is selected for access, viewing or playback, it is accessed, viewed or played after it has been decrypted; but while it is stored on the personal versatile recorder disk (106), it remains encrypted. This also allows the user to have full motion control of the content itself as in a video-on-demand application but without having to use complex video servers at the headend or tying up network capacity for the duration of the program. Instead the network capacity used is only during the download of the content.

For multimedia content in the form of a pay-per-view event, the set-top terminal/personal versatile recorder unit (200) provides the option of applying a purchase fee for the pay-per-view event at a time other than when the order is placed. An option for selecting the assessment of the purchase fee include charging the pay-per-view purchase fee when the event has been accessed, or played back from the personal versatile recorder disk (106). In charging a purchase fee when the pay-per-view content is accessed or played back from the personal versatile recorder disk (106), the set-top terminal/personal versatile recorder unit (200) performs in the following manner.

Initially, the pay-per-view content is transferred to the set-top terminal/personal versatile recorder unit (200) as a compressed digital data bit stream. The digital data bit stream is compressed using a compression technique such as an MPEG video compression technique, and the like. When this compressed digital data bit stream is transferred as encrypted, modulated data, such as when the compressed digital data bit stream is transferred directly from a multiple-channel programming network, the encrypted, modulated, compressed data bit stream is demodulated and decrypted by the set-top terminal/personal versatile recorder unit (200) to produce a compressed data bit stream. The compressed data bit stream is then decoded to convert the compressed data bit stream into an analog audiovisual signal.

As an additional feature of the present invention, when transcoding is desired in order to change the compression rate, signal format and/or resolution, an analog-to-digital conversion is performed to the analog audiovisual signal for re-encoding the analog audiovisual signal into a re-compressed data bit stream. The re-compressed data bit stream is then transcoded to the desired compression rate, signal format and/or resolution. This re-compressed, transcoded, data bit stream is then stored onto the personal versatile recorder disk (106).

As another feature of the present invention, the re-compressed, transcoded data bit stream is re-encrypted prior to storage onto the personal versatile recorder disk (106). The re-encryption is performed either using software or using hardware incorporated within the set-top terminal/personal versatile recorder unit (200), to produce a re-compressed, transcoded, re-encrypted data bit stream. The re-encryption scheme need not be identical to the original encryption scheme of the demodulated signal. The re-compressed, transcoded, re-encrypted data bit stream is then stored onto the personal versatile recorder disk (106).

As an alternative feature of the present invention, transcoding may be performed without the intermediate step of converting the compressed data bit stream into an analog audiovisual signal.

As an alternate feature of the present invention, when transcoding is not required, the encrypted, compressed data bit stream may remain encrypted or may be decrypted and re-encrypted for copy protection. The compressed digital bit stream is transferred onto the personal versatile recorder disk (106) for storage prior to decryption or decompression, and prior to conversion into an analog audiovisual signal.

The stored data bit stream is read from the personal versatile recorder disk (106), decrypted when stored as encrypted data, and decoded for viewing. Once the stored data bit stream is read, decrypted and decoded, the purchase event is registered as viewed by reporting the event back to a billing controller (not shown) and the purchase fee is applied.

As another alternate feature of the present invention, a preview time period authorization is contained within a message that is sent from the headend to the set-top terminal/personal versatile recorder unit (200). This preview time period authorization permits the viewing of the pay-per-view event without charge during the preview time period. Once the preview time period has lapsed, the purchase event is registered as a viewing by reporting the event back to the billing controller and the purchase fee is applied.

Since the pay-per-view event is likely to be copyright-protected content, the set-top terminal/personal versatile recorder unit (200) performs an inquiry to determine the existence of the requisite permission needed to maintain the content on the personal versatile recorder disk (106). When the permission to maintain the content on the personal versatile recorder disk (106) exists, the stored data bit stream remains on the personal versatile recorder disk (106) after it has been viewed until the time that the stored data bit stream is subsequently overwritten with another data bit stream or deleted. Conversely, when the permission to maintain the content on the personal versatile recorder disk (106) does not exist, the stored data bit stream is deleted from the personal versatile recorder disk (106) after it has been viewed.

The set-top terminal/personal versatile recorder unit (200) additionally permits the user to select the fee structure for the registration and assessment of the purchase fee. The fee structure includes the registration and assessment of the purchase fee when the event has been viewed. The fee structure also includes the registration and assessment of a partial charge upon recording the pay-per-view event and another partial charge upon when viewing the event, with the sum total of the partial charges equaling the purchase fee.

Another advantage of the personal Versatile Recorder is its utility in storing network-monitoring parameters and signal quality parameters in real time for later retrieval. Embedded or network-based trend analysis software is used to predict or detect network performance and/or degradation with greater granularity, such as the prediction or detection per residence or per device within a residence.

The set-top terminal/personal versatile recorder unit (200) of the present invention can be incorporated into a wireless home network. In accordance with this feature, the set-top terminal/personal versatile recorder unit (200) wirelessly shares content and services with peripheral devices that are located throughout the home. For example, through this wireless home network, music that has been previously recorded based on a user profile or music from a music service such as Music Choice®, or other content, is transmitted to an addressable wireless headphone or an addressable system component over the wireless networking link. This wireless home networking feature is not limited to the transmission of music.

To interface the personal versatile recorder of the present invention with other devices and systems, a number of additional interfaces are provided. For example, to interface a digital camera for multimedia mail applications, an IEEE1394 digital bus (107) or a Universal Serial Bus (USB) (108) are utilized. To transfer the files to a personal computer, or 10/100BT BaseT ethernet data interface (109), can be used. Also shown are connections to other peripheral devices (105). Through the connections (105), the IEEE1394 digital bus (107), the Universal Serial Bus (USB) (108), or the 10/100BT interface (109), the set-top terminal/personal versatile recorder unit (200) may record from another peripheral device such as an FM tuner, a compact disk (CD) player, a digital versatile disk (DVD) player, an MPEG Layer 3 (MP3) player, and the like. The prerequisites are a digitized stream with a networked access between the personal versatile recorder and these peripheral devices.

The user's television set (not shown) is connected to the video/audio outputs (119) thereby allowing the user to watch the selected programming. Furthermore, an RF bypass (113) allows direct signal routing to the connected television set, or to another device that includes a video cassette recorder, and the like.

The preceding description has been presented only to illustrate and describe the invention. It is not intended to be exhaustive or to limit the invention to any precise form disclosed. Many modifications and variations are possible in light of the above teaching.

The preceding description is intended to enable others skilled in the art to best utilize the invention in various embodiments and with various modifications as are suited to the particular use contemplated. It is intended that the scope of the invention be defined by the following claims.

What is claimed is:

1. A personal versatile recording apparatus comprising:
means for programming said personal versatile recording apparatus to record a selected event; and
means for recording said selected event,
wherein said selected event is recorded in its entirety despite the occurence of a schedule change or an overrun of the selected event.

2. The personal versatile recording apparatus of claim 1, wherein: said means for programming said personal versatile recording apparatus is a user interface.

3. The personal versatile recording apparatus of claim 1, wherein: said personal versatile recording apparatus includes means for registering with an electronic programming guide server so that said personal versatile recording apparatus is notified by said electronic programming guide server when said selected event has ended.

4. The personal versatile recording apparatus of claim 3, wherein: upon completion of said selected event, said electronic programming guide server sends at least one multicast message to said personal versatile recording apparatus to notify said personal versatile recording apparatus that said selected event has ended.

5. The personal versatile recording apparatus of claim 3, wherein: upon completion of said selected event, said electronic programming guide server broadcasts the end time for said selected event regardless of the time said personal versatile recording apparatus has been instructed to record said selected event.

6. The personal versatile recording apparatus of claim 1, wherein: data produced by an electronic programming guide server is used by said personal versatile recording apparatus to determine the starting time and the ending time for recording said selected event, said data being updated in near-real-time.

7. The personal versatile recording apparatus of claim 6, wherein: the recording of said selected event beginning at a first time that is immediately before said starting time and ending at a second time that is immediately after said ending time.

8. The personal versatile recording apparatus of claim 7, wherein: said first time and said second time being determined in near-real-time by said updated data produced by said electronic programming guide server.

9. The personal versatile recording apparatus of claim 7, wherein: the portion of said selected event that has been recorded before said first time and after said second time is deleted from the recording.

10. The personal versatile recording apparatus of claim 1, wherein: a tag having an event start indication and an event end indication is included within an information stream corresponding to said selected event.

11. The personal versatile recording apparatus of claim 10, wherein: said tag requiring manual oversight at the source of said information stream.

12. The personal versatile recording apparatus of claim 10, wherein: said tag is within a descriptor placed within a program map table.

13. The personal versatile recording apparatus of claim 10, wherein: said tag is a separate message.

14. A personal versatile recording apparatus comprising:
a personal recording apparatus programmed to record a selected event and for recording said selected event; and
an interface for recording said selected event from another peripheral device.

15. The personal versatile recording apparatus of claim 14, wherein:
said wireless home network includes at least one wireless headphone.

16. The personal versatile recording apparatus of claim 14, wherein: said another peripheral device comprises one of an FM tuner, a CD player, a DVD player, and an MP3 player.

17. A personal versatile recording apparatus comprising:
a personal recording apparatus programmed to record a selected event and for recording said selected event,
said personal recording apparatus being incorporated into a wireless home network.

18. A personal versatile recording apparatus comprising:
means for programming said personal versatile recording apparatus to record a selected event; and
means for recording said selected event, said selected event is music, said music conforming to a listener profile.

19. The personal versatile recording apparatus of claim 18, wherein: said music is recorded onto a compact disk.

20. A personal versatile recording apparatus comprising:
device for programming said personal versatile recording apparatus to record a selected event;
device for recording said selected event, said selected event being music, wherein
said personal versatile recording apparatus tags, for recording, said music that is in progress to record said music at a later time.

21. A personal versatile recording apparatus comprising:
means for demodulating an event to produce an encrypted, compressed data bit stream;
means for decrypting the encrypted, compressed data bit stream to produce a compressed data bit stream;
means for decoding the compressed data bit stream to produce an analog audiovisual signal;
means for re-encoding the analog audiovisual signal to produce a re-compressed data bit stream.
means for transcoding the re-compressed data bit stream to produce a re-compressed, transcoded data bit stream;
means for storing the re-compressed, transcoded data bit stream onto said storage medium to produce a stored data bit stream;
means for reading the stored data bit stream from said storage medium to produce a read data bit stream;
means for decoding the read data bit stream; and
means for registering said decoded event.

22. The personal versatile recording apparatus of claim 21, further comprising:
means for performing contents rights management.

23. The personal versatile recording apparatus of claim 21, further comprising:
means for permitting the viewing of said event without charge during a preview time period.

24. The personal versatile recording apparatus of claim 21, further comprising:
means for reporting the event back to a billing controller.

25. A method for recording an event using a personal versatile recording apparatus, the method comprising:
selecting said event to record;
programming said personal versatile recording apparatus to record said selected event; and
recording said selected event to produce a recorded event,
wherein said recorded event is recorded in its entirety despite the occurence of a schedule change or overrun of the selected event.

26. The method of claim 25, wherein: said apparatus for programming said personal versatile recording apparatus is a user interface.

27. The method of claim 25, further comprising:
registering with an electronic programming guide server so that said personal versatile recording apparatus is notified by said electronic programming guide server when said selected event has ended.

28. The method of claim 27, wherein:
upon completion of said selected event, said electronic programming guide server sends at least one multicast message to said personal versatile recording apparatus to notify said personal versatile recording apparatus that said selected event has ended.

29. The method of claim 27, wherein:
upon completion of said selected event, said electronic programming guide server broadcasts the end time for said selected event regardless of the time said personal versatile recording apparatus has been instructed to record the event.

30. The method of claim 25, further comprising:
using data produced by an electronic programming guide server to determine the appropriate start and end times for recording said selected event, said data being updated in near-real-time.

31. The method of claim 30, wherein:
said recording begins at a first time that is immediately before the starting time of said selected event and ends at a second time that is immediately after completion time of said selected event.

32. The method of claim 31, wherein:
said data being said first time and said second time.

33. The method of claim 32, wherein:
deleting from said recorded event, portions of said recorded event recorded before said first time and after said second time.

34. The method of claim 25, further comprising:
placing a tag, having an event start indication and an event end indication, within an information stream corresponding to said selected event.

35. The method of claim 34, wherein:
said step of placing said tag requires manual oversight at the source of said information stream.

36. The method of claim 34, wherein:
said tag being in a descriptor placed within a program map table.

37. The method of claim 34, wherein:
said tag being a separate message.

38. A method for recording an event using a personal versatile recording apparatus, the method comprising:
selecting said event to record;
programming said personal versatile recording apparatus to record said selected event, said personal versatile recording apparatus including an interface for recording from another peripheral device; and
recording said selected event to produce a recorded event.

39. The method of claim 38, wherein:
said another peripheral device comprises one of an FM tuner, a CD player, a DVD player, and an MP3 player.

40. A method for recording an event using a personal versatile recording apparatus, the method comprising:
selecting said event to record;
programming said personal versatile recording apparatus to record said selected event, said personal versatile recording apparatus being incorporated into a wireless home network; and
recording said selected event to produce a recorded event.

41. The method of claim 40, wherein:
said wireless home network includes at least one wireless headphone.

42. A method for recording an event using a personal versatile recording apparatus, the method comprising:
selecting said event to record;
programming said personal versatile recording apparatus to record said selected event; and
recording said selected event to produce a recorded event, said selected event being content conforming to a listener profile.

43. The method of claim 42, wherein: said content being recorded onto a compact disk.

44. A method for recording an event using a personal versatile recording apparatus, the method comprising:
selecting said event to record;
programming said personal versatile recording apparatus to record said selected event, said personal versatile recording apparatus tags, for recording, said music that is in progress to record said music at a later time; and
recording said selected event to produce a recorded event.

45. A method for registering an event using a personal versatile recording apparatus having a storage medium thereon, the method comprising:
demodulating said event to produce a demodulated event;
decrypting said demodulated event to produce a decrypted event;
decoding said decrypted event to produce a decoded event;
converting said decoded event into an analog signal;
encoding said digital stream to produce an encoded digital stream;
transcoding said encoded digital stream to produce a transcoded event;
storing said transcoded event onto said storage medium to produce a stored event;
reading said stored event from said storage medium to produce a read event;
decoding said read event to produce a decoded event; and
registering said decoded event.

46. The method of claim 45, wherein:
said transcoded event is re-encrypted after said transcoding step.

47. The method of claim 46, wherein:
said read event is decrypted before said decoding step.

48. The method of claim 45, wherein:
said decoded event is displayed for viewing.

49. The method of claim 45, further comprising:
assessing a fee when said event is read from said storage medium for viewing.

50. The method of claim 45, further comprising:
assessing a partial charge when said transcoded event is stored; and
assessing an additional partial charge when said read event is viewed,
wherein the sum total of said partial charge and said additional partial charge equals a fee.

51. A method for registering an event using a personal versatile recording apparatus having a storage medium thereon, the method comprising:
demodulating said event to produce an encrypted, compressed data bit stream,
decrypting the encrypted, compressed data bit stream to produce a compressed data bit stream;
decoding the compressed data bit stream to produce an analog audiovisual signal;
re-encoding the analog audiovisual signal to produce a re-compressed data bit stream.
transcoding the re-compressed data bit stream to produce a re-compressed, transcoded data bit stream;
storing the re-compressed, transcoded data bit stream onto said storage medium to produce a stored data bit stream;
reading the stored data bit stream from said storage medium to produce a read data bit stream;
decoding the read data bit stream; and
registering said event.

52. The method of claim 5 1, further comprising:
re-encrypting the re-compressed, transcoded data bit stream prior to said storing step.

53. The method of claim 51, wherein:
said re-encrypting step is performed using software.

54. The method of claim 51, wherein:
said re-encrypting step is performed using hardware.

55. The method of claim 51, wherein:
said re-encrypting step is performed using the same encryption scheme used to encrypt the encrypted, compressed data bit stream.

56. The method of claim 51, wherein:
said re-encrypting step is performed using an encryption scheme different from the encryption scheme used to encrypt the encrypted, compressed data bit stream.

57. A method for registering an event using a personal versatile recording apparatus having a storage medium thereon, the method comprising:
demodulating said event to produce an encrypted, compressed data bit stream,
decrypting the encrypted, compressed data bit stream to produce a compressed data bit stream;
storing the compressed data bit stream onto said storage medium to produce a stored data bit stream;
reading the stored data bit stream from said storage medium to produce a read data bit stream;
decoding the read data bit stream; and
registering said event.

58. A method for registering an event using a personal versatile recording apparatus having a storage medium thereon, the method comprising:
demodulating said event to produce a demodulated event;
storing said demodulated event onto said storage medium to produce a stored event;
reading said stored event from said storage medium to produce a read event;
decrypting said read event to produce a decrypted event; and
registering said decrypted event.

59. The method of claim 58, further comprising:
assessing a fee when said decrypted event is viewed.

60. The method of claim 58, further comprising:
assessing a partial charge when said demodulated event is stored; and
assessing an additional partial charge when said decrypted event is viewed,
wherein the sum total of said partial charge and said additional partial charge equals a fee.
